(19) United States
(12) Patent Application Publication
(10) Pub. No.: US 2013/0130606 A1
(43) Pub. Date: May 23, 2013

(54) SWIVEL CONNECTOR FOR CHIMNEY SHIELD AND METHOD OF MAKING THE SAME

(71) Applicant: Eric Brunette, Boisbriand (CA)

(72) Inventor: Eric Brunette, Boisbriand (CA)

(21) Appl. No.: 13/298,982

(22) Filed: Nov. 17, 2011

(51) Int. Cl. F23J 13/02; F16C 11/04; B23P 19/04

(52) U.S. Cl. 454/47; 29/428; 403/53

(57) ABSTRACT

A swivel joint for a chimney shield is provided. In one embodiment, the swivel joint comprises a first cylindrical member and a second cylindrical member having an end portion received in an end portion of said first cylindrical member and rotatably coupled to the first cylindrical member. The first and second cylindrical members extends along a central longitudinal axis and the first and second cylindrical members rotate independently of one another about a plane perpendicular to the central longitudinal axis.

### TECHNICAL FIELD

This application is directed, in general, to a chimney shield system and, more specifically, to a swivel joint for a chimney shield.

### BACKGROUND

Modern day chimneys often consist of sheet metal that are formed into elongated, cylindrically shaped pipe joints that are joined together to span the distance from the fireplace or firebox to outside the structure being heated. In most instances, due to the fact that the sheet metal is typically very thin, many governmental regulations now require that the chimneys be additionally insulated to protect against the possibility of fires occurring due to the hot chimney pipe. To address this issue, manufacturers have developed an insulative shield that encompasses the chimney. These shields are also sheet metal that are formed into elongated, cylindrically shaped pipe joints that typically have an insulative material, such as foam or fiberglass located between two cylindrically formed pieces of sheet metal. The insulative shield has an inner diameter that is larger than the chimney, which allows it to be wrapped around the chimney. Typically, the inner diameter is large enough to allow a gap to exist between the outer wall of the chimney and the inner wall of the shield, thereby providing an additional insulative effect.

In original construction, these shields are placed about the chimney before the chimney is boxed in with wall materials. As such, the installer can easily access all sides of the shield joints, which allows the installer to adequately secure the joints together. However, in after-construction situations, these shields can be very difficult to install because, often times, only one side of the chimney is exposed. This makes securing the joints together properly more difficult, because all sides of the shield cannot be reached due to the limited access space.

### SUMMARY

One aspect of the present disclosure provides a swivel joint for a chimney shield. In one embodiment, the swivel joint comprises a first cylindrical member and a second cylindrical member having an end portion received in an end portion of the first cylindrical member and that is rotatably coupled to the first cylindrical member. The first and second cylindrical members extend along a central longitudinal axis. Also, the first and second cylindrical members rotate independently of one another about a plane perpendicular to the central longitudinal axis.

Another aspect provides a chimney shield system. In one embodiment, the chimney shield system comprises a first cylindrical shield member, a second cylindrical shield member, and a swivel joint. The swivel joint includes a first cylindrical member and a second cylindrical member that is rotatably coupled to the first cylindrical member. The first and second cylindrical members extend along a central longitudinal axis. The first and second cylindrical members rotate independently of one another about a plane perpendicular to the central longitudinal axis, and the swivel joint is configured to couple the first and second cylindrical members together.

Another aspect provides a method of manufacturing a swivel joint for a chimney shield. In one embodiment, the method comprises providing a first cylindrical member, providing a second cylindrical member, and rotatably coupling the first cylindrical member to the second cylindrical member by inserting an end portion of the second cylindrical member into an end portion of the first cylindrical member. The first and second cylindrical members extend along a central longitudinal axis, and the first and second cylindrical members rotate independently of one another about a plane perpendicular to the central longitudinal axis.

### BRIEF DESCRIPTION

Reference is now made to the following descriptions taken in conjunction with the accompanying drawings, in which:

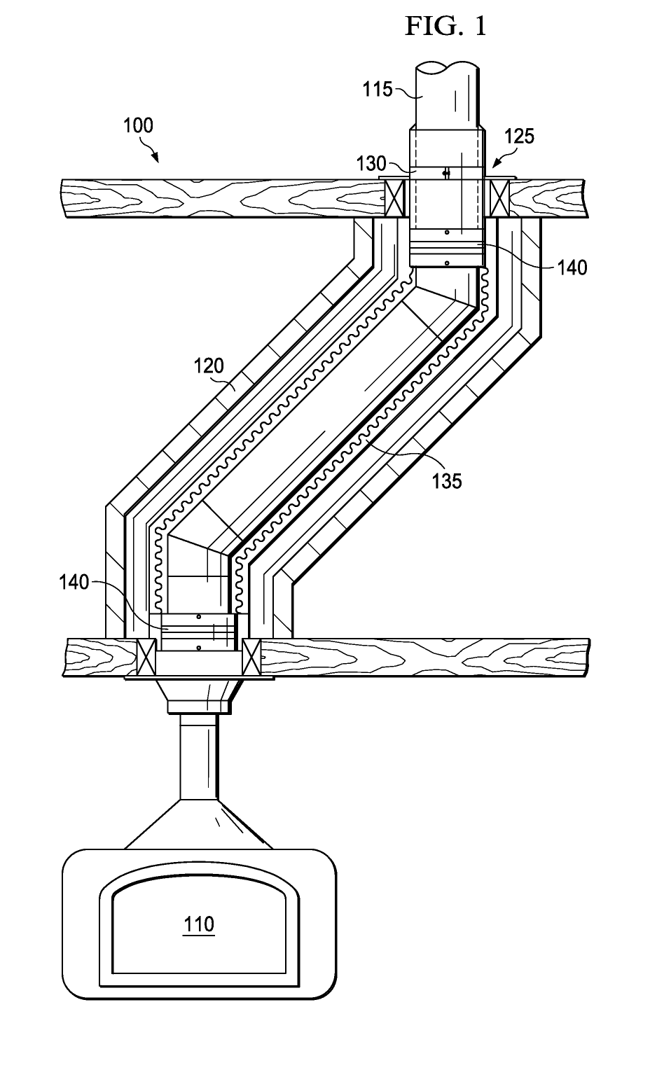

FIG. 1 is an environmental view of a fireplace or fire box in which the embodiments, as presented herein, can be employed;

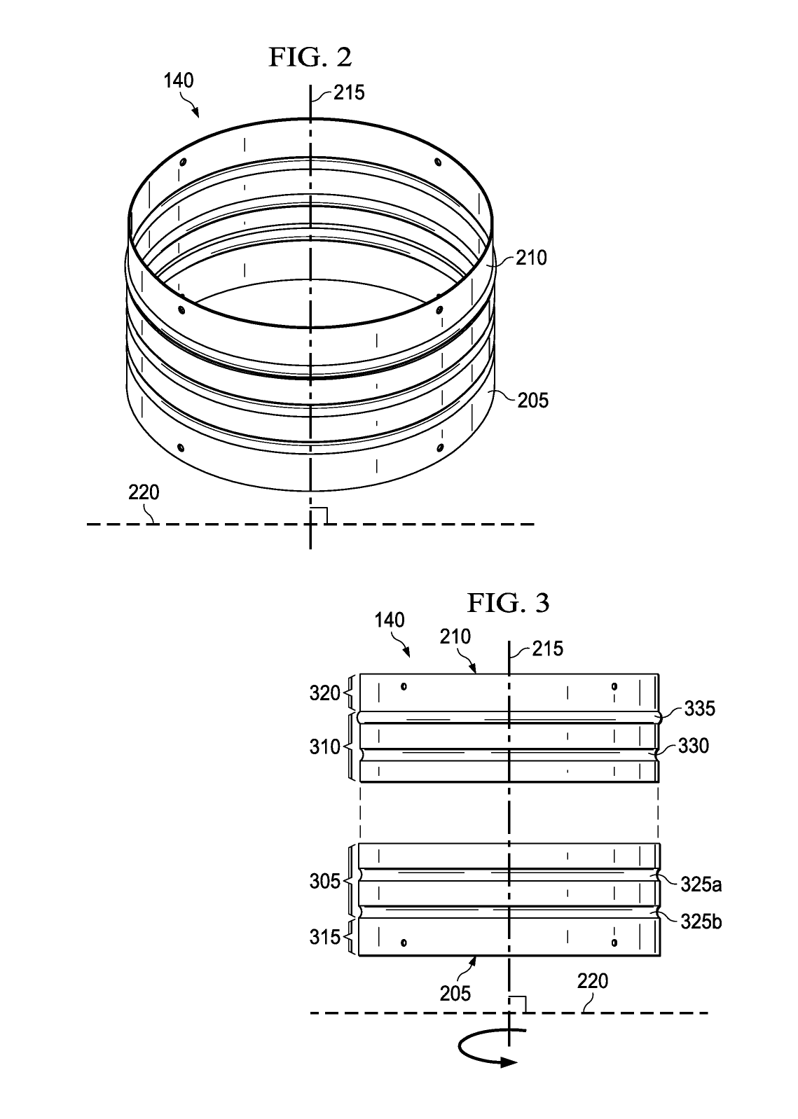

FIG. 2 is a perspective view of one embodiment of the swivel joint as provided herein;

FIG. 3 is a side view of one of the embodiment shown in FIG. 2;

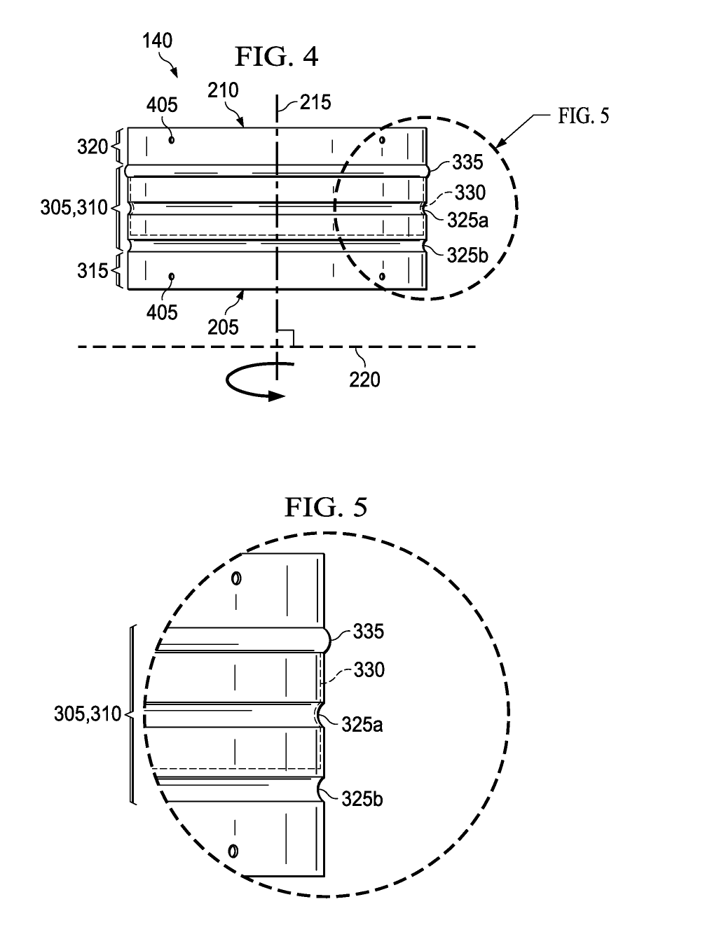

FIG. 4 is a side view of one of the embodiment shown in FIG. 3; and

FIG. 5 is a closer side view of the embodiment shown in FIG. 4.

### DETAILED DESCRIPTION

As stated above, in after-construction installation situations, installing a shield over a chimney requires opening a side of the chimney enclosure to gain access to the chimney, while minimizing structural damage to the existing chimney enclosure. Once access to the chimney is obtained through the opened side, the shields are then connected to the adjacent shields, e.g., top and bottom shields, across the opened side. The opened side, however, only exposes a fraction of the shield's circumference, making its connection with the adjacent shields weak. The chimney shield system becomes vulnerable to collapses and failure, e.g., misalignment, especially in the areas that are not vertically oriented.

Described herein are embodiments of a swivel joint that can be used to install a chimney shield about an existing chimney, and methods of making it such that the joint facilitates stronger and easier connections among the joints of the shield. The swivel joint comprises cylindrical members that can rotate independently of each other such that, once one member is coupled to a chimney shield, the coupled member and chimney shield can be swiveled or rotated together, which allows the installer to couple the chimney shield joints together about their entire circumference.

FIG. 1 is a cross sectional view of one embodiment of a chimney shield system 100 that can be used with a fireplace or firebox 110 (hereinafter fireplace 110) and existing chimney 115. The fireplace 110 may be a gas fireplace or a wood burning fireplace. Additionally, it may be a freestanding fireplace or be built in, and it may also be an existing fireplace or may be built, or installed concurrently with the installation of the chimney shield system 100. The chimney 115 is of conventional design as described above. During original construction, a chimney duct or raceway 120 is constructed of framing or walling material. This framing or walling material forms the four-sided duct 120 around the chimney 115. When a homeowner wishes to change a fireplace 110 or chimney 115, or bring an existing chimney 115 into compliance with current building code or regulation, it is necessary for the installer to remove one side of the duct 120 to gain access to the chimney 115, so that the chimney shield system 100 can be installed. Typically only one side of the duct 120 is removed to minimize damage to the original duct 120 structure. In such instances, the chimney shield system 100 can be used to insure a more stable and rigid chimney shield.

As seen in the embodiment of FIG. 1, the chimney shield system 100 comprises a shield member 125. The shield member 125 can be of conventional design as explained above and may comprise a rigid individual joint 130, a flexible joint 135, or a combination thereof, as shown, that are coupled together by swivel joints 140, as presented herein. As seen in this embodiment, the chimney shield system 100 is enclosed within the duct 120 that contains a slanted portion offset by elbows and is connected to the fireplace 110. It should be understood that the chimney shield system and the swivel joint's 140 applications are not limited to existing chimneys and that they can be used during original chimney construction as well.

In an installation application, one wall of a chimney duct 120 is removed, thereby allowing access to the existing chimney. A swivel joint 140 is attached to an exposed portion of collar that encompasses the chimney 115. A chimney shield 135 may then be wrapped around the chimney, and one of its ends can be attached to the swivel joint 140. A screw is placed through the coupling end of the swivel joint 140 and the chimney shield 135. The rotation of the swivel joint 140 allows one of the cylindrical members of the swivel joint 140 and the chimney shield 135 to which it is attached to be rotated, at which point another screw can be used to further couple the swivel joint 140 and the chimney shield 135 together. This process is repeated until the joints have been rotated as much as 360 degrees. Then, a second swivel joint 140 is attached to the opposite end of the chimney shield 135 and attached in the same manner as just described. This process is repeated until all chimney shield joints have been installed.

FIG. 2 is a perspective view of an embodiment of the swivel joint 140, as seen in FIG. 1. In this embodiment, the swivel joint 140 comprises two cylindrical members, a first cylindrical member 205 and a second cylindrical member 210. First and second cylindrical members 205, 210 are rotatably coupled to one another and extend along a line that runs longitudinally through the centers of both first and second cylindrical members 205, 210. This line will be referred hereinafter as a central longitudinal axis 215. It should be understood that the swivel joint 140 can be made of any corrosion resisting materials such as galvanized steel or iron, hard plastics, or other composite materials.

First and second cylindrical members 205, 210 are rotatably coupled together in a way that one member can rotate independently of another member about a plane 220, which is perpendicular to the central longitudinal axis 215. It should be understood that the swivel joint 140 can have more than two cylindrical members so that it will have more than one swiveling joint that is capable of independently rotating about the plane 220. This rotation about the plane that is perpendicular to the central longitudinal axis 215 provides advantages over conventional joints that are designed to rotate about a plane that is not perpendicular to their central longitudinal axis. Such conventional designs cannot be used in existing chimneys in that the joints cannot be rotated sufficiently to provide adequate attachment points, because the wall of the chimney duct would block the non-perpendicular rotation of the swivel joint.

FIG. 3 is a side view of the embodiment of the swivel joint 140 shown in FIG. 2. In this view, the first and second cylindrical members 205, 210 are shown before they are rotatably coupled together. Each of the first and second cylindrical members 205, 210 comprises a swiveling portion 305, 310 and a coupling portion 315, 320, respectively. The inner diameter of the first cylindrical member 205 is larger than the outer diameter of the second cylindrical member 210. As such when first and second cylindrical member 205, 210 are coupled, the swiveling portion 305 of the first cylindrical member 205 overlaps a portion of the swiveling portion 310 of the second cylindrical member 210.

Swiveling portion 305 of the first cylindrical member 205 comprises one or more grooves 325. Grooves 325 are formed in an outer surface of the swiveling portion 305 and extend parallel to the plane 220, which is perpendicular to the central longitudinal axis 215.

Swiveling portion 310 of the second cylindrical member 210 comprises a groove 330 and a ridge 335. Groove 330 and the ridge 335 are formed in an outer surface of the swiveling portion 310 and extend parallel to the plane 220 which is perpendicular to the central longitudinal axis 215. As explained below, the grooves 325, 330 cooperatively engage each other when the first and second cylindrical members 205, 210 are coupled together to provide rotation of the first and second cylindrical members 205, 210 with respect to each other.

FIG. 4 is a side view of the embodiment of the swivel joint 140 shown in FIG. 3 when the first and second cylindrical members 205, 210 are coupled together. As can be seen, an end of the swivel portion 310 of the second cylindrical member 210 is received in an end of the swivel portion 305 of the first cylindrical member 205. Groove 330 of the second cylindrical member 210 is received and overlapped by one of the grooves 325a, located adjacent the end of the swivel portion 305 of the first cylindrical member 205. It should be understood that the number of the grooves in the first and second cylindrical members 205, 210 that overlap each other is not limited to the number shown in this embodiment. It should also be understood that the shapes of the overlapping grooves 325, 330 do not have to be rounded as shown in this embodiment as long as the can be cooperatively engaged with each other to provide rotation of the first and second cylindrical members 205, 210 with respect to each other.

First and second cylindrical members 205, 210, in certain embodiments may also comprise a plurality of optional, attachment orifices 405 around their respective coupling portions 315, 320. Orifices 405 are located adjacent an end of the coupling portions 315, 320, so that each of the orifices 405 will line up with orifices in the connecting shield member and receive a fastening device, such as a screw. In this embodiment, each of the orifices 405 of the swivel joint 140 is equally spaced apart from each other along the direction perpendicular to the central longitudinal axis 215. While each the first and second cylindrical members 205, 210 of this embodiment has four orifices 405, the number of orifices may vary depending on the applications and circumstances. Moreover, the orifices 405 may receive fastening devices other than screws depending on the applications and circumstances. In other embodiments, however, the orifices 405 may not be present and the attachment of the swivel joint 140 to the shield member may simply be made by punching a screw through both of the joints, which is often done in the assembly of sheet metal joints.

FIG. 5 is a closer view of the swiveling portion 305, 310 of the first and the second cylindrical members 205, 210 of the embodiment shown in the FIG. 4. As mentioned above, the swiveling portion 310 of the second cylindrical member 210 is received in the swiveling portion 305 of the first cylindrical member 205. One of the grooves 325a of the first cylindrical member 205 overlaps the groove 330 of the second cylindrical member 210, and the end of the swiveling portion 305 of the first cylindrical member 205 abuts the ridge 335 of the second cylindrical member 210. The end of the swiveling portion 310 of the second cylindrical member 210 also gets close to the groove 325 of the first cylindrical member 205. The ridge 335 of the second cylindrical member 210 and the groove 325 of the first cylindrical member 205 keeps the plane of the first and second cylindrical members' 205, 210 rotations parallel to each other and to a direction perpendicular to the central longitudinal axis 215. Ridge 335 of the second cylindrical member 210 and one of the grooves 325b of the first cylindrical member 205 also prevents the first and second cylindrical members 205, 210 from easily decoupling from each other.

In a method of manufacturing embodiment, the first cylindrical member 205, as discussed above, is provided. As used herein and in the claims, “provided or providing” includes those instances where the recited component is fabricated by the manufacturer or obtained from an outside source (e.g, subsidiary) or a third party source. The second cylindrical member 210, as discussed above, is also provided. The first and second cylindrical members 205, 210 are rotatably coupled together by inserting the swiveling portion 310 of the second cylindrical member 210 into the swiveling portion 305 of the second cylindrical member 205, until the groove 330 of the second cylindrical member 210 is received in the groove 325a of the first cylindrical member 205. The first and second cylindrical members 205, 210 have a height that extends along a central longitudinal axis. The cooperative engagement of the grooves 325a and 330 are such that the first and second cylindrical members 205, 210 are allowed to easily rotate independently of one another about a plane 220 perpendicular to the central longitudinal axis 215.

From the foregoing, a swivel joint is provided that allows for a shield member to be installed about an existing chimney. The free rotation of the swivel joints allows an installer to rotate the swivel joint and the chimney shield to which it is to be attached as much as 360 degrees. This allows the installer to place as many screws as necessary to provide adequate coupling and support between the swivel joint and the chimney shield, even when only one side of the chimney is exposed.

Those skilled in the art to which this application relates will appreciate that other and further additions, deletions, substitutions and modifications may be made to the described embodiments.

What is claimed is:

1. A swivel joint for a chimney shield, comprising:
a first cylindrical member;
a second cylindrical member having an end portion received in an end portion of said first cylindrical member and rotatably coupled to said first cylindrical member, said first and second cylindrical members extending along a central longitudinal axis, wherein said first and second cylindrical members rotate independently of one another about a plane perpendicular to said central longitudinal axis.

2. The swivel joint of claim 1, wherein each of said first and second cylindrical members comprise a groove formed in an outer surface thereof, located adjacent an end thereof and parallel to the plane perpendicular to said central longitudinal axis, said groove of said first cylindrical member overlapping said groove of said second cylindrical member.

3. The swivel joint of claim 2, wherein said second cylindrical member comprising a ridge formed in said outer surface thereof and parallel to said plane perpendicular to said central longitudinal axis and wherein said end of said first cylindrical member abuts said ridge.

4. The swivel joint of claim 1, wherein first cylindrical member comprising a second groove formed in an outer surface thereof and parallel to said plane perpendicular to said central longitudinal axis.

5. The swivel joint of claim 1, wherein said first and second cylindrical members include a plurality of equally spaced orifices located adjacent end portions of said swivel joint and along said plane perpendicular to said central longitudinal axis.

6. A chimney shield system, comprising:
a first cylindrical shield member;
a second cylindrical shield member; and
a swivel joint, comprising:
a first cylindrical member;
a second cylindrical member rotatably coupled to said first cylindrical member, said first and second cylindrical members extending along a central longitudinal axis, wherein said first and second cylindrical members rotate independently of one another about a plane perpendicular to said central longitudinal axis, said swivel joint configured to couple said first and second cylindrical members together.

7. The chimney system of claim 7, wherein each of said first and second cylindrical members comprise a groove formed in an outer surface thereof, located adjacent an end thereof, and parallel to said plane perpendicular to said central longitudinal axis, said groove of said first cylindrical member overlapping said groove of said second cylindrical member.

8. The chimney system of claim 8, wherein said second cylindrical member comprising a ridge formed in said outer surface thereof and parallel to said plane perpendicular to said central longitudinal axis and wherein said end of said first cylindrical member abuts said ridge.

9. The chimney system of claim 7, wherein first cylindrical member comprising a second groove formed in an outer surface thereof and parallel to said plane perpendicular to said central longitudinal axis.

10. The chimney system of claim 7, wherein an end portion of said second cylindrical member is received in an end portion of said first cylindrical member.

11. The chimney system of claim 7, wherein said first and second cylindrical members include a plurality of equally spaced orifices located adjacent end portions of said swivel joint and along said plane perpendicular to said central longitudinal axis.

12. The chimney system of claim 7, wherein at least one of said cylindrical shield members is flexible.

13. A method of manufacturing a swivel joint for a chimney shield, comprising:
providing a first cylindrical member;
providing a second cylindrical member;
rotatably coupling said first cylindrical member to said second cylindrical member by inserting an end portion of said second cylindrical member into an end portion of said first cylindrical member, wherein said first and second cylindrical members extend along a central longitudinal axis and said first and said first and second cylindrical members rotate independently of one another about a plane perpendicular to said central longitudinal axis.

14. The method of claim 13, wherein providing said first and second cylindrical members comprises providing each of said first and second cylindrical members including a groove formed in an outer surface thereof, located adjacent an end thereof, and parallel to said plane perpendicular to said central longitudinal axis.

15. The method of claim 14, wherein rotatably coupling said first cylindrical member to said second cylindrical member such that said groove of said first cylindrical member overlaps said groove of said second cylindrical member.

16. The method of claim 14, wherein providing said second cylindrical member comprises providing said second cylindrical member including a ridge formed in said outer surface thereof and parallel to said plane perpendicular to said central longitudinal axis.

17. The method of claim 16, wherein rotatably coupling said first cylindrical member to said second cylindrical member such that said end of said first cylindrical member abuts said ridge.

18. The method of claim 13, wherein providing said first cylindrical member comprises providing said first cylindrical member including a second groove formed in an outer surface thereof and parallel to said plane perpendicular to said central longitudinal axis.

19. The method of claim 13, wherein providing said first and second cylindrical members comprises providing said first and second cylindrical members including a plurality of equally spaced orifices located adjacent end portions of said swivel joint and along said plane perpendicular to said central longitudinal axis.
